(19) United States
(12) Patent Application Publication
(10) Pub. No.: US 2005/0104782 A1
(43) Pub. Date: May 19, 2005

(54) Antenna with virtual magnetic wall

(76) Inventors: Asher Peled, Even Yehuda (IL); Ehud Heyman, Tel Aviv (IL); Bon-Zion Steinberg, Kfar Saba (IL); Raphael Kastner, Hod Hasharon (IL)

Correspondence Address: DARBY & DARBY P.C., P. O. BOX 5257, NEW YORK, NY, 10150-5257, US

(21) Appl. No.: 10/433,386

(22) PCT Filed: Dec. 6, 2001
(86) PCT No.: PCT/IL01/01126

Related U.S. Application Data
(60) Provisional application No. 60/255,570, filed on Dec. 14, 2000.

(51) Int. Cl. H01Q 1/24; H01Q 1/52

(52) U.S. Cl. 343/702; 343/841

(57) ABSTRACT

A radiation shield (36) includes a virtual magnetic wall (VMW), which is adapted to be placed between a radiating antenna (34) and an object (30) so as to reflect electromagnetic radiation emitted from the antenna in a given frequency band and having an electric field with a given polarization, away from the object. The electric field of the radiation reflected by the VMW is substantially in phase with the electric field of the emitted radiation incident on the VMW.

### CROSS-REFERENCE TO RELATED APPLICATION

This application claims the benefit of U.S. Provisional Patent Application No. 0/255,570, filed Dec. 14, 2000, which is incorporated herein by reference.

### FIELD OF THE INVENTION

The present invention relates generally to antennas, and specifically to devices and methods for controlling the Specific Absorption Rate (SAR) of radiation from the antenna of a mobile communication device in the tissues of a user of the device.

### BACKGROUND OF THE INVENTION

Concern has been growing over the radiation hazard involved in use of cellular telephones. Complaints of headaches, dizziness and fatigue are common among heavy users of cellular phones. Recent studies have indicated that long exposure to radio frequency (RF) radiation emitted by cellular phone antennas could cause serious medical problems due to the interference with brain cell activity, possibly leading to brain cancer. Some governments have already started warning users in regard to risks associated with use of cell phones. Recently, the British government has issued a recommendation to parents to limit the time their children use mobile phones. In the United States and in other countries, cellular and other wireless handsets must meet regulatory requirements for maximum specific absorption rate (SAR) levels in body tissues.

The concerns about the adverse health effects of cellular phone use arise from the fact that their antennas can deliver large amounts of RF energy to very small areas of the user's brain. In many cases, over 70% of the electromagnetic power emitted by the antenna in the 800-900 MHz band is absorbed in the human head. Although the radio frequency emissions of wireless handsets are classified as non-ionizing, they are able to transfer energy in the form of heat to any absorptive material. The antenna location, near field emission characteristics, radio frequency power, and frequency establish the basis for conformance to SAR limits. Energy absorption in the head also introduces extra loss into the power budget of the cellular phone itself, causing increased power consumption and reduced battery life for a given level of antenna emission.

Some attempts to reduce the health hazards of radio telephone antennas use RF-absorbing materials to shield the head. For example, U.S. Pat. Nos. 5,666,125 and 5,777,586, whose disclosures are incorporated herein by reference, describe an antenna assembly that includes a radiation absorber defining an open curved shape. At least some of the radiation emitted from the antenna in directions toward the user is blocked by the radiation absorber. Similarly, U.S. Pat. No. 5,694,137, whose disclosure is incorporated herein by reference, describes an arc-shaped shield, made of material impervious to radiation, which is positionable along an exterior of an antenna. While such absorbing shields may reduce the SAR in the head, however, they only aggravate the power loss problem. Therefore, an optimal antenna design should be based on improving efficiency of the radiation pattern as the key means for reducing SAR in body tissues.

As an alternative to absorbing materials, manufacturers often use electrically-conducting (grounded) surfaces to shield the user from the antenna. For example, U.S. Pat. No. 6,088,579 describes a radio communication device that has a conductive shielding layer between the antenna and the user. The shielding layer may be movable away from the antenna when not in use. Similarly, U.S. Pat. No. 5,613,221 describes a radiation shield for a hand-held cellular telephone made of a metal strip placed between the antenna rod of the telephone and the user. U.S. Pat. No. 6,075,977 describes a dual-purpose flip shield for retrofit to an existing hand-held cellular telephone. The shield, made of a polished material, preferably aluminum, is flipped up to a position between the telephone antenna and the user's head when the telephone is in use so as to provide high reflectance of electromagnetic waves away from the user. Other conductive antenna shielding devices are described in U.S. Pat. Nos. 6,088,603, 6,137,998, 6,097,340, 5,999,142 and 5,335,366. The disclosures of all the patents mentioned in this paragraph are incorporated herein by reference.

Conductive shields of the types described in these patents are not very effective in redirecting antenna energy, however, particularly when monopole antennas are involved. The problems with conductive shields stem from the fact that the boundary condition of the electromagnetic fields on a conductive surface requires the total electric field tangential to the surface to be zero. Therefore, the conductive surface necessarily has a reflection coefficient with a phase shift of 180° in the electric field. For the direct and reflected fields to be in phase, so that the antenna field is not canceled (shorted out) by destructive interference, the distance between the antenna and the reflector must be one quarter wave, which is about 8 cm in the 800-900 MHz band. To implement this solution with a monopole antenna is cumbersome, since the reflecting element must be located between the user and the antenna, meaning that the antenna itself must be at least 8 cm from the user's head.

In view of the known drawbacks of conductive reflectors, there have been attempts to improve their performance by addition of other electrical elements. For example, U.S. Pat. No. 6,114,999, whose disclosure is incorporated herein by reference, describes an antenna device for a mobile phone, wherein a distance between a miniaturized radiator and a miniaturized reflector is shortened by means of an introduced dielectric material. As an additional means for reducing the field directed toward the user, at least two thin isolated metal strips run parallel to the edges of the reflector element to form chokes at the back of the reflector, so as to concentrate the near-field to an area between the chokes. European Patent Application EP 0 588 271 A1, whose disclosure is likewise incorporated herein by reference, describes an antenna for a portable transceiver having an asymmetric radiation pattern. At least one reflector can be placed in a back zone of the antenna radiator. It is suggested that the reflector can be made of tuned dipoles operating in a passive manner, or by a vertical reflecting screen composed of densely-spaced horizontal turns.

Other antenna designs, such as patch antennas and variants on the loop antenna, permit more design flexibility without resorting to cumbersome reflector elements. These designs, however, have not shown the necessary near-field behavior to reduce SAR in the head. Another practice known in the art is to generate a quasi-directional far-field free-space pattern, rather than an omni-directional pattern. For example, U.S. Pat. No. 6,031,495, whose disclosure is incorporated herein by reference, describes an antenna system for reducing SAR that uses a pair of phased radiating elements to create a bi-directional radiation pattern with high attenuation perpendicular to the user's head. In the near field, however, the RF power density toward the user is not necessarily reduced by such an approach.

### SUMMARY OF THE INVENTION

It is an object of the present invention to provide improved structures and methods for directing a radiated electromagnetic field. It is a further object of some aspects of the present invention to provide antennas with enhanced near-field directional characteristics.

It is yet a further object of some aspects of the present invention to provide devices and methods for reducing the SAR in the head of a user of RP radiation emitted by personal communication devices, such as cellular telephones.

It is still a further object of some aspects of the present invention to provide antennas for use with personal communication devices that reduce the overall device power budget.

In preferred embodiments of the present invention, a virtual magnetic wall (VMW) is interposed between an antenna on a personal communication device, such as a cellular telephone, and the head of a user. The VMW reflects radiation emitted by the antenna, thus generating a near-field radiation pattern that is directed preferentially away from the user's head. Electrically-conductive reflectors, as described above, must cancel the incident electric field at their surface and thus reflect the radiated electric field with reversed phase. The VMW, on the other hand, acts as a “magnetic conductor,” in the sense that it cancels the magnetic field while reflecting the electric field in phase with the incident field. As a result, unlike electrically-conductive reflectors, the VMW generates constructive interference of the electric field. It can therefore be positioned as close as is desired to the antenna and still give efficient control of the antenna's near-field radiation pattern.

Perfect magnetic conductors are not known to exist in nature. Instead, the VMW comprises a structure that approximates the behavior of such a magnetic conductor for a particular frequency range and polarization of the incident field. The VMW is preferably designed and constructed so that in response to the field of the antenna incident on the surface of the VMW, an equivalent magnetic current flows at the surface in the proper phase with the electric current so as to create radiation in the direction away from the user's head. In preferred embodiments of the present invention, the VMW comprises one or more of the following elements exhibiting such behavior:
A cavity which acts as an open-circuited resonant circuit.
A slot array, backed by a cavity and excited in the proper phase with the main antenna radiator.
A corrugated surface, or loaded corrugated surface, which acts as a RF choke to block the electric currents from flowing over the surface.
A cavity formed by a folded or meandered shorted transmission line, which exhibits an open circuit at the input terminal, while preferably occupying a small volume.
   Other implementations of the VMW meeting the criteria described above are considered to be within the scope of the present invention.

The VMW is thus able to redirect the radiation pattern of the antenna on a cellular telephone or other personal communication device so that the radiation is emitted preferentially in a direction away from the user's head. Because the VMW can be placed arbitrarily close to the antenna, it can be made small in size, with minimal impact on the mechanical design of the communication device. Furthermore, since the VMW is itself substantially non-absorbing of radiation, and it reduces absorption of radiation from the antenna in the user's head, it increases the efficiency of radiation of the antenna and improves the overall device power budget.

Although preferred embodiments described herein are directed to personal communication devices, and particularly to protecting users of such devices from RF radiation emitted by device antennas, the usefulness of the present invention is by no means limited to such applications. Rather, the principles and techniques of the present invention may be applied to produce electromagnetic reflectors and directional antenna assemblies for other uses, as well.

There is therefore provided, in accordance with a preferred embodiment of the present invention, a radiation shield including a virtual magnetic wall (VMW), which is adapted to be placed between a radiating antenna and an object so as to reflect electromagnetic radiation emitted from the antenna in a given frequency band and having an electric field with a given polarization, away from the object, such that the electric field of the radiation reflected by the VMW is substantially in phase with the electric field of the emitted radiation incident on the VMW.

Preferably, the VMW is adapted to emulate a perfect magnetic conductive surface, such that a tangential component of a magnetic field of the radiation reflected by the VMW is out of phase with the tangential component of the magnetic field of the radiation incident on the VMW by approximately 180°.

In a preferred embodiment, the VMW includes a front surface and a back surface, which define at least one cavity therebetween, having a resonance in a vicinity of the given frequency. Preferably, at least one slot is formed in the front surface of the VMW, opening into the cavity. Most preferably, the at least one slot includes a plurality of slots, which are oriented responsive to the polarization of the emitted radiation. In a further preferred embodiment, the VMW also includes one or more lumped circuit elements coupled across the at least one slot. Preferably, the at least one cavity includes a plurality of cavities.

Preferably, the VMW includes one or more fins, positioned in the at least one cavity so as to enhance a capacitance of the cavity. Most preferably, at least one of the one or more fins is oriented in a direction generally perpendicular to the surfaces of the VMW or, alternatively, in a direction generally parallel to the surfaces of the VMW.

Further preferably, the VMW includes a dielectric or magnetic material, which is contained in the at least one cavity.

In another preferred embodiment, the VMW includes an array of inductors and capacitors, arranged to form one or more circuits having a resonance in a vicinity of the given frequency. Preferably, the array includes one or more inductive coils, having gaps therein that define the capacitors.

In still another preferred embodiment, the VMW includes a surface having periodic corrugations therein, which are configured to block electric currents from flowing over the surface.

In yet another preferred embodiment, the VMW includes a surface and one or more shorted transmission lines having input terminals at the surface and configured to exhibit an open circuit at the input terminals. Preferably, the transmission lines include folded transmission lines or, alternatively or additionally, meandered transmission lines. Most preferably, the transmission lines are approximately one quarter wave in length in the given frequency band.

Preferably, the VMW includes a structure having a resonance in the given frequency band, which is configured to respond to the incident radiation as an open-circuited resonant circuit. Most preferably, the given frequency band is between approximately 800 and 900 MHz or between approximately 1800 and 1900 MHz.

There is also provided, in accordance with a preferred embodiment of the present invention, an antenna assembly for a personal communication device, including:

an antenna, coupled to be driven by the device so as to emit electromagnetic radiation in a given frequency band and with a given polarization; and

a virtual magnetic wall (VMW), positioned between the antenna and a head of a user of the device so as to reflect the radiation emitted by the antenna away from the head, such that an electric field of the radiation reflected by the VMW is substantially in phase with the electric field of the emitted radiation incident on the VMW.

Preferably, the VMW is positioned at a distance from the antenna that is substantially less than one quarter of a wavelength of the radiation. Typically, the antenna includes a monopole antenna. Alternatively or additionally, the antenna may include an array of antennas.

There is additionally provided, in accordance with a preferred embodiment of the present invention, a method for shielding an object from radiation emitted by an antenna in a given frequency band and having a given polarization, the method including positioning a virtual magnetic wall (VMW) between the antenna and the object so as to reflect the radiation emitted by the antenna away from the object, such that an electric field of the radiation reflected by the VMW is substantially in phase with the electric field of the emitted radiation incident on the VMW.

The present invention will be more fully understood from the following detailed description of the preferred embodiments thereof, taken together with the drawings in which:

### BRIEF DESCRIPTION OF THE DRAWINGS

FIG. 1 is a schematic side view of two electromagnetic reflectors, useful in understanding the principles of the present invention;

FIG. 2 is a schematic, pictorial illustration of a cellular telephone with a virtual magnetic wall (VMW) antenna shield, in accordance with a preferred embodiment of the present invention;

FIG. 3 is a schematic, pictorial illustration of an antenna with a VMW, in accordance with a preferred embodiment of the present invention;

FIG. 4 is a schematic, sectional view of the antenna and VMW of FIG. 3;

FIG. 5 is a schematic, pictorial illustration of an antenna with a VMW that includes lumped circuit elements, in accordance with a preferred embodiment of the present invention;

FIG. 6 is a schematic, sectional view of an antenna with a VMW, in accordance with another preferred embodiment of the present invention;

FIG. 6 is a plot that schematically illustrates radiation patterns emitted by an antenna, with and without a VMW antenna shield;

FIGS. 7A, 7B, 8 and 9 are schematic, sectional views of antennas with VMWs, in accordance with further preferred embodiments of the present invention;

5 FIG. 10 is a schematic, pictorial illustration of an antenna with a VMW, in accordance with another preferred embodiment of the present invention;

FIG. 11 is a schematic, pictorial illustration of an antenna with a corrugated VMW, in accordance with a preferred embodiment of the present invention;

FIGS. 12 and 13 are schematic, pictorial illustrations of antennas with VMWs based on shorted transmission lines, in accordance with other preferred embodiments of the present invention; and

FIG. 14 is a schematic, sectional view of an antenna array with a VMW, in accordance with yet another preferred embodiment of the present invention.

### DETAILED DESCRIPTION OF PREFERRED EMBODIMENTS

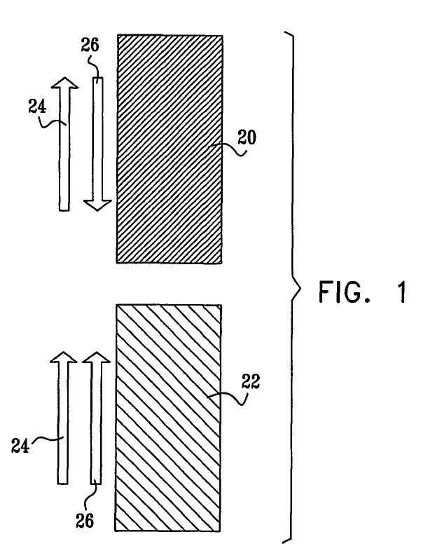

Reference is now made to FIG. 1, which is a schematic side view of a perfect electrical conductor 20 and a “perfect magnetic conductor” 22, on which an electromagnetic field is incident. A first arrow 24 shows the phase of the incident electric field component tangential to the surface of conductors 20 and 22, while a second arrow 26 shows the phase of the reflected electric field. While electrical conductor 20 reflects the electric field 180° out of phase with the incident field, magnetic conductor 22 reflects the electric field in phase with the incident field. As noted above, “magnetic conductors” are not known in nature. Rather, in preferred embodiments of the present invention, a variety of structures are defined that approximate the behavior of the perfect magnetic conductor by providing the in-phase reflection behavior shown in FIG. 1.

Whereas electrical conductor 20 short-circuits the incident field (giving a tangential electric field E=0 at the surface of the conductor), magnetic conductor 22 behaves as an “open circuit” plane. Therefore, unlike an electrically-conductive reflector, which must be spaced from an antenna by a quarter wave in order to give efficient reflection, the magnetic conductor can be placed very close to the antenna and still perform the same finction. At the surface of magnetic conductor 22, the tangential magnetic field Hₜₐₙ, rather than the electric field, becomes very small. (A zero magnetic field would imply a perfect open circuit). The image of the antenna is thus in phase with the antenna current, which serves to redirect the radiation away from the surface. In other words, regardless of how close magnetic conductor 22 is to the antenna, it reflects the radiation of the antenna away from the user's head, while nulling the radiation in the direction of the head.

As described further hereinbelow, virtual magnetic walls (VMWs) are structures that emulate, approximately, the behavior of a perfect magnetic conductor for electromagnetic radiation within a specified frequency range and polarization. The operation of a VMW can be described physically by any of the following models:
The surface acts approximately as a magnetic conductor.
The surface produces an in-phase reflection coefficient for the electric field, as opposed to the out-of-phase reflection coefficient of the conventional grounded electrical conductor.
The surface of the VMW has high impedance, wherein the impedance is defined as Eₜₐₙ/Hₜₐₙ. A high value of the impedance implies suppression of the magnetic field.
The surface is backed by a structure, such as one or more cavities, that acts as an open-circuited resonant circuit. An open circuit implies a low magnetic field.
In response to an incident electric field, a current distribution is created over the surface of the magnetic conductor. The phase of the current distribution is such that interference between the reflected field, generated due to the current, gives rise to radiation in a direction back toward the source of the incident field, while nulling the radiation in the direction through the magnetic reflector.
   A reflector that exhibits any of these characteristics can be regarded as a VMW.

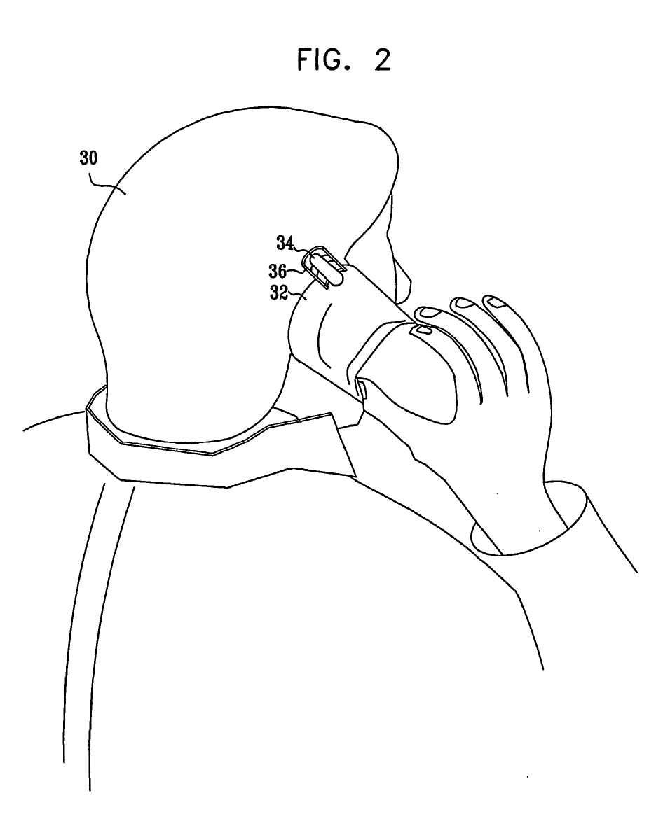

FIG. 2 is a schematic, pictorial illustration showing a cellular telephone 32 held next to a head 30 of a user, in accordance with a preferred embodiment of the present invention. Telephone 32 comprises an antenna 34, typically a monopole antenna, as is known in the art. A VMW 36 is mounted on telephone 32 between antenna 34 and head 30, in order to direct radiation from the antenna away from the user's head. Preferably, the VMW is curved, as shown in the figure, to provide effective blockage of radiation over the entire range of angles occupied by the head. Alternatively, the VMW may be flat or may have some other shape appropriate to the mechanical design and ergonomics of the telephone and the antenna. In any case, the effect of VMW 36 is to create a wider and shallow aperture distribution between antenna 34 and head 30, so that the antenna radiation effectively bypasses the head. Thus, SAR is reduced, while the overall efficiency of the antenna is increased.

Various structures can be used to create VMW 36. In preferred embodiments of the present invention, these structures include:
A VMW made up of an array of cavity-backed slots, preferably of minimal depth, distributed over the front surface of the VMW. The cavity-backed slots radiate in a direction away from head 30, reinforcing the radiation from the main radiator in that direction and nulling the radiation in the direction toward the head.
A VMW made of one or more cavities with lumped capacitors and inductors attached to their apertures. These lumped elements produce an open-circuited resonant circuit, thereby reducing the total magnetic field over the surface.
A VMW with a corrugated surface, possibly a loaded corrugated surface, acting as a RF choke to block electric currents from flowing over the surface. Such surfaces are often used inside feed horns of large reflector antennas (“corrugated horns,” also known as “scalar feeds”) and around their apertures. Multiple corrugated surfaces, with corrugations periodic along one dimension or along two dimensions (also known as Photonic Band Gap (PBG) structures) can also be utilized for this purpose.
A VMW made of one or more cavities formed by a folded or meandered shorted transmission line, typically, but not necessarily, a quarter wave in length, or a combination of such lines, with or without lumped capacitors or inductors attached to the input terminals, such that an open circuit is exhibited at the input terminals of the line. These terminals coincide with the VMW surface.
   Some specific implementations of these embodiments are shown in the figures that follow. Alternative structures will be apparent to those skilled in the art.

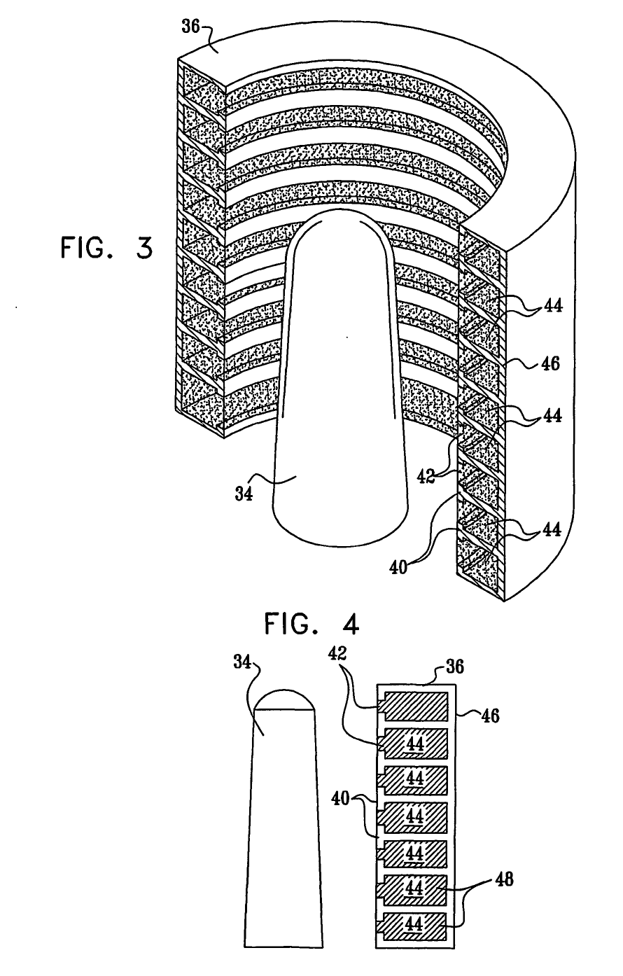

Reference is now made to FIGS. 3 and 4, which schematically show details of VMW 36, in accordance with a preferred embodiment of the present invention. FIG. 3 is a pictorial view of antenna 34 and VMW 36, while FIG. 4 shows a cross-section of these elements. In this embodiment, multiple parallel slots 42 are formed or cut into a front surface 40 of the VMW. Each slot is backed by a cavity 44, formed between front surface 40 and a back surface 46 of the VMW. Slots 42 are oriented horizontally, so as to accord with the vertical polarization of the electric field and horizontal polarization of the magnetic field emitted by vertical antenna 34. The sizes and shapes of cavities 44 are such as resonate at the antenna frequency, thereby generating a strong reflected electric field in phase with the field of the antenna, while the reflected magnetic field is 180° out of phase with the incident field.

In the embodiment of FIGS. 3 and 4, as well as in the alternative embodiments described below, the total number of cavities 44 or slots 42 can be from one to eight or more. The physical dimensions of the slots and cavities are determined by the center frequency and bandwidth required. The walls separating the individual cavities may be replaced by combinations of perforations and wires, in order to enhance inter-cavity couplings. Preferably, cavities 44 are filled with a dielectric or magnetic material 48, so as to improve their coupling and reduce their size relative to the design wavelength. Alternatively or additionally, the region between the VMW and the antenna may also be filled with a dielectric or magnetic material. Materials that can be used for this purpose include Teflon™-based dielectrics, foam materials, polypropylene, polyimides, ferrite materials, silicon, germanium and other dielectric and magnetic materials known in the art.

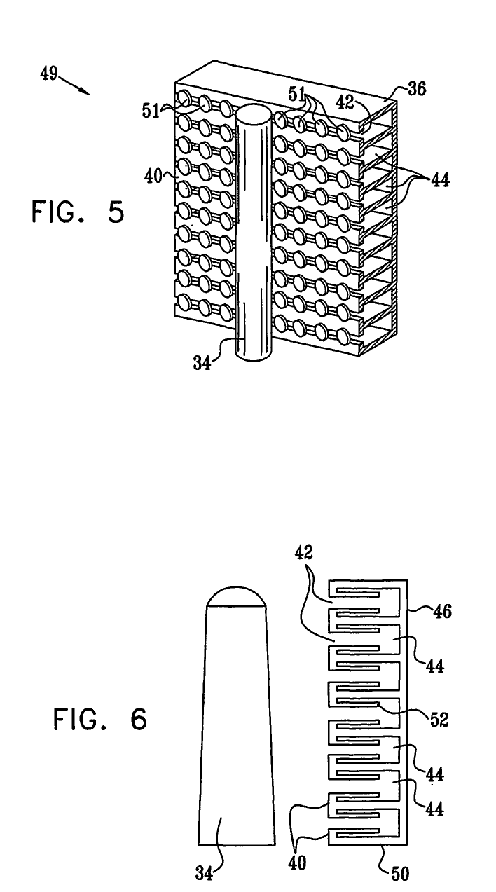

FIG. 5 is a schematic, pictorial view of antenna 34 with another VMW-based reflector 49, in accordance with a preferred embodiment of the present invention. Reflector 49 is similar in structure to VMW 36, described above, with the addition of lumped circuit elements 51 over slots 42. Lumped elements 51, which typically comprise capacitors and/or inductors, are useful in reducing the total magnetic field over surface 40 of VMW 36. By proper choice and placement of lumped elements 51, it is thus possible to improve the performance of the VMW or to reduce the size of cavities 44 while maintaining a desired performance level.

FIG. 6 is a schematic, sectional view of a VMW 50, in accordance with another preferred embodiment of the present invention. In this embodiment, horizontal fins 52 are added in each of cavities 44 in order to increase the capacitance of the cavities and thus enhance their coupling to the incident radiation and/or reduce their size. Cavities 44 are preferably filled with dielectric or magnetic material, as described above. In an alternative embodiment (not shown in the figures), lumped elements, preferably capacitors, are placed over the cavity openings for the same purpose.

Table I below lists typical dimensions for an exemplary design of VMW 50 consisting of three cavities 44, which are filled with a dielectric material having a dielectric constant of 4. The dimensions in the table are given in units of the radiation wavelength of antenna 34.

TABLE I
DIMENSIONS OF EXEMPLARY MULTI-CAVITY VMW

| Item | Dimension (λ) |
|---|---|
| Height of antenna 34 | 0.15625 |
| Distance from antenna to back surface 46 | 0.0875 |
| Height of cavities 44 | 0.05 |
| Width of slots 42 | 0.00625 |
| Depth of cavities 44 | 0.025 |
| Length of fins 52 | 0.021875 |

In this configuration, the far-field radiation pattern of the antenna assembly is stronger by 3 dB relative to a standard monopole antenna. The structure also aids in matching the antenna to its feed line. In addition, the enhanced antenna efficiency also reduces the power budget of telephone 32, so that its battery life is prolonged.

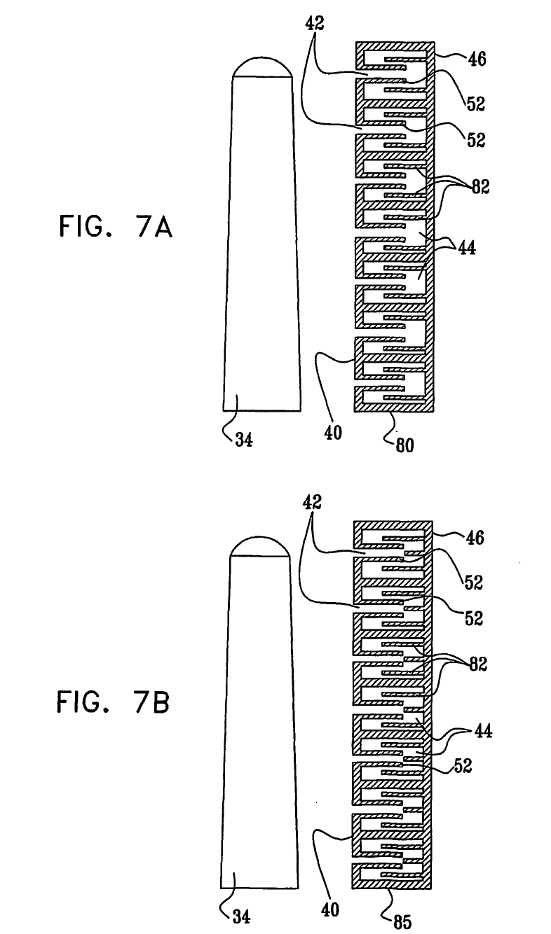

FIGS. 7A and 7B are schematic, sectional views of VMW 80 and VMW 85, respectively, in accordance with further preferred embodiments of the present invention. In these embodiments, the capacitance of cavities 44 is further enhanced by the addition of horizontal fins 82 inside the cavities. In VMW 80 there are two such fins in each cavity, while in VMW 85 there are three. Other fin configurations will be apparent to those skilled in the art.

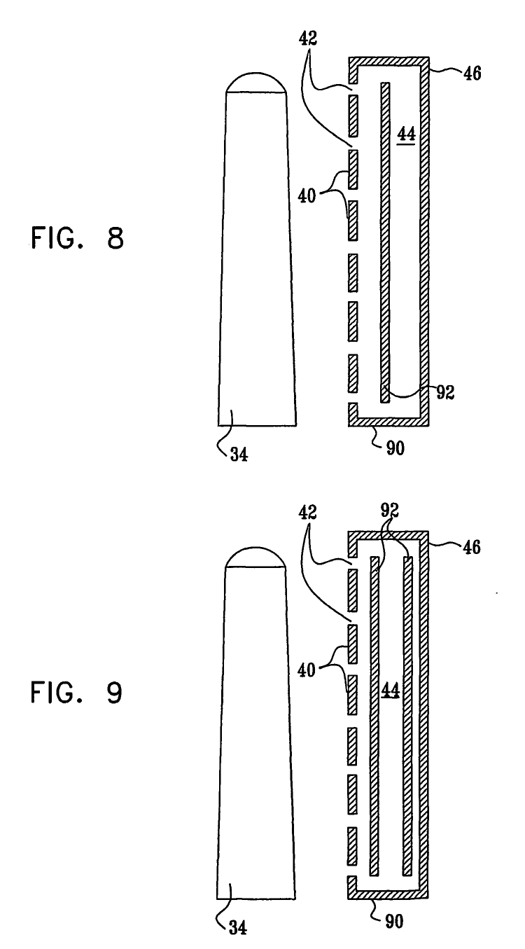

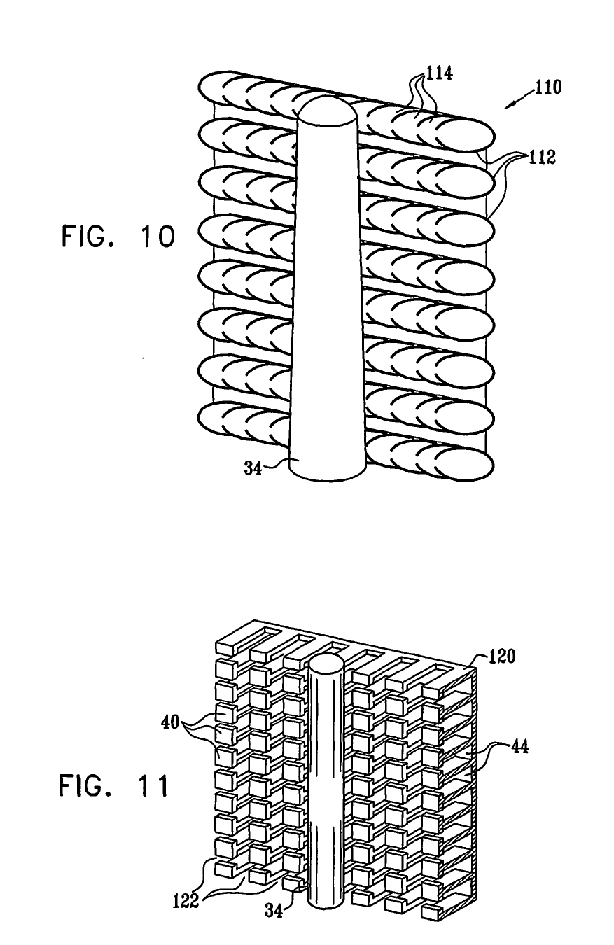

FIGS. 8 and 9 are schematic, sectional views of VMW 90 and VMW 100, respectively, in accordance with still further preferred embodiments of the present invention. In these embodiments, the VMW contains a single cavity 44, with one or more vertical fins 92 for enhanced capacitance. Table II below lists typical dimensions for an exemplary design of VMW 90 having a single slot 42 (rather than multiple slots as shown in FIG. 8). Cavity 44 is filled with a dielectric material having a dielectric constant of 4, as in the example shown in Table I. Fin 92 is centered in the cavity.

TABLE II
DIMENSIONS OF EXEMPLARY SINGLE-CAVITY VMW

| Item | Dimension (λ) |
|---|---|
| Height of antenna 34 | 0.15625 |
| Distance from antenna to back surface 46 | 0.0875 |
| Height of cavity 44 | 0.15 |
| Width of slot 42 | 0.05 |
| Depth of cavity 44 | 0.025 |
| Length of fin 92 | 0.12 |

In this configuration, as in the configuration represented by Table I, the far-field radiation pattern of the antenna assembly is stronger by 3 dB relative to a standard monopole antenna, and the antenna is matched to its feed line.

FIG. 10 is a schematic, pictorial illustration of antenna 34 with a VMW 110, in accordance with another preferred embodiment of the present invention. VMW 110 comprises multiple coils 112, which serve as inductors. Gaps 114 in coils 112 serve as capacitors, thus defining resonant circuits with resonance at the operating frequency of antenna 34. Alternatively or additionally, lumped capacitors may be used across gaps 114. The resonant circuits formed by coils 112 together with gaps 114 serve substantially the same purpose as do cavities 44 in the embodiments described above.

FIG. 11 is a schematic, pictorial illustration of antenna 34 with a VMW, in accordance with still another preferred embodiment of the present invention. VMW 120 has a corrugated surface 40, formed by periodic corrugations 122 in both vertical and horizontal directions. As noted above, the corrugations act as a RF choke to block electric currents from flowing over the surface. VMW may also include lumped elements, such as capacitors and inductors, across the input terminals of the multi-dimensional corrugations, similar to elements 51 shown in FIG. 5. The lumped elements serve again, as before, to reduce the magnetic field intensity at surface 40 and/or to enable smaller cavities 44 to be used.

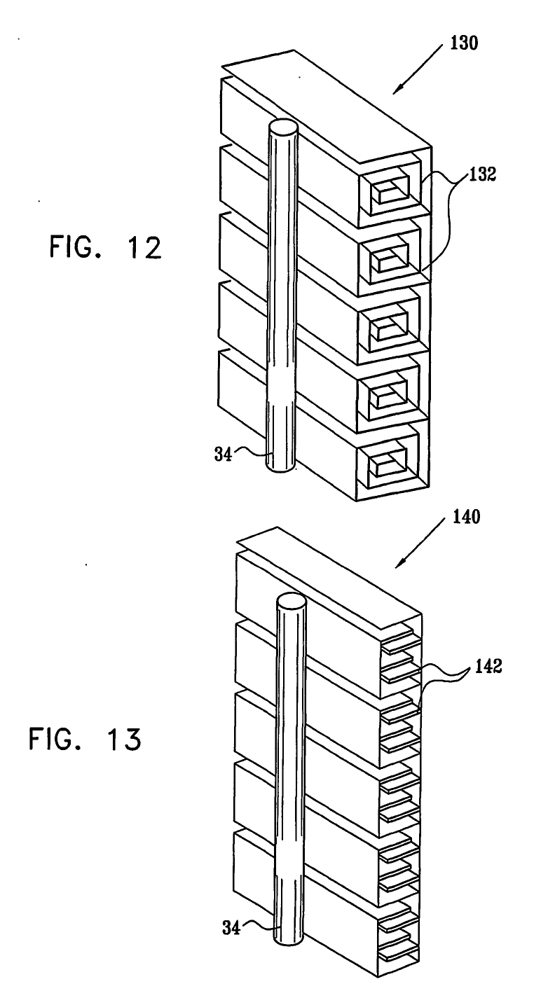

FIG. 12 is a schematic, pictorial illustration of antenna 34 with a VMW 130 made from cavities defined by folded, shorted transmission lines 132, in accordance with yet another preferred embodiment of the present invention. Preferably (though not necessarily), each transmission line 132 is a quarter wave in length, and is configured so that an open circuit is exhibited at the input terminals of the line at surface 40. As in preceding embodiments, lumped elements (not shown in this figure) may be coupled across the input terminals.

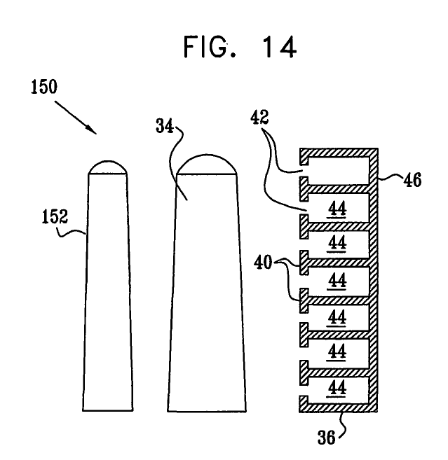

FIG. 13 is a schematic, pictorial illustration of antenna 34 with another VMW 140, in accordance with a preferred embodiment of the present invention. In this case, VMW 140 is made from cavities defined by meandered transmission lines 142.

FIG. 14 is a schematic, sectional view of an antenna array 150, in accordance with yet another preferred embodiment of the present invention. Array 150 comprises antenna 34 as its main radiator and an auxiliary antenna 152. VMW 36 is interposed between antenna 34 and the user's head (not shown in this figure), as described above. Antenna 152 is driven passively in appropriate phase with antenna 34, serving as a radiation director. The antenna array and VMW work in cooperation to reduce still further the radiation absorbed in the head and to increase the efficiency of transmission. VMWs may likewise be used in conjunction with other types of antennas and antenna arrays, as are known in the art.

Although preferred embodiments are described herein with specific reference to cellular telephones, the principles of the present invention are similar applicable to the construction of elements for shielding and redirection of radiation from devices of other types. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A radiation shield comprising a virtual magnetic wall (VMW), which is adapted to be placed between a radiating antenna and an object so as to reflect electromagnetic radiation emitted from the antenna in a given frequency band and having an electric field with a given polarization, away from the object, such that the electric field of the radiation reflected by the VMW is substantially in phase with the electric field of the emitted radiation incident on the VMW.

2. A shield according to claim 1, wherein the VMW is adapted to emulate a perfect magnetic conductive surface.

3. A shield according to claim 1, wherein a tangential component of a magnetic field of the radiation reflected by the VMW is out of phase with the tangential component of the magnetic field of the radiation incident on the VMW by approximately 180°.

4. A shield according to claim 1, wherein the VMW comprises a front surface and a back surface, which define at least one cavity therebetween, having a resonance in a vicinity of the given frequency.

5. A shield according to claim 4, wherein at least one slot is formed in the front surface of the VMW, opening into the cavity.

6. A shield according to claim 5, wherein the at least one slot comprises a plurality of slots.

7. A shield according to claim 5, wherein the at least one slot is oriented responsive to the polarization of the emitted radiation.

8. A shield according to claim 5, wherein the VMW further comprises one or more lumped circuit elements coupled across the at least one slot.

9. A shield according to claim 4, wherein the at least one cavity comprises a plurality of cavities.

10. A shield according to claim 4, wherein the VMW comprises one or more fins, positioned in the at least one cavity so as to enhance a capacitance of the cavity.

11. A shield according to claim 10, wherein at least one of the one or more fins is oriented in a direction generally perpendicular to the surfaces of the VMW.

12. A shield according to claim 10, wherein at least one of the one or more fins is oriented in a direction generally parallel to the surfaces of the VMW.

13. A shield according to claim 4, wherein the VMW comprises a dielectric or magnetic material, which is contained in the at least one cavity.

14. A shield according to claim 1, wherein the VMW comprises an array of inductors and capacitors, arranged to form one or more circuits having a resonance in a vicinity of the given frequency.

15. A shield according to claim 13, wherein the array comprises one or more inductive coils, having gaps therein that define the capacitors.

16. A shield according to claim 1, wherein the VMW comprises a surface having periodic corrugations therein, which are configured to block electric currents from flowing over the surface.

17. A shield according to claim 1, wherein the VMW comprises a surface and one or more shorted transmission lines having input terminals at the surface and configured to exhibit an open circuit at the input terminals.

18. A shield according to claim 17, wherein the transmission lines comprise folded transmission lines.

19. A shield according to claim 17, wherein the transmission lines comprise meandered transmission lines.

20. A shield according to claim 17, wherein the transmission lines are approximately one quarter wave in length in the given frequency band.

21. A shield according to claim 1, wherein the VMW comprises a structure having a resonance in the given frequency band, which is configured to respond to the incident radiation as an open-circuited resonant circuit.

22. A shield according to claim 1, wherein the given frequency band is between approximately 800 and 900 MHz.

23. A shield according to claim 1, wherein the given frequency band is between approximately 1800 and 1900 MHz.

24. An antenna assembly for a personal communication device, comprising:
an antenna, coupled to be driven by the device so as to emit electromagnetic radiation in a given frequency band and with a given polarization; and
a virtual magnetic wall (VMW), positioned between the antenna and a head of a user of the device so as to reflect the radiation emitted by the antenna away from the head, such that an electric field of the radiation reflected by the VMW is substantially in phase with the electric field of the emitted radiation incident on the VMW.

25. An assembly according to claim 24, wherein the VMW is. positioned at a distance from the antenna that is substantially less than one quarter of a wavelength of the radiation.

26. An assembly according to claim 24, wherein the VMW is adapted to emulate a perfect magnetic conductive surface.

27. An assembly according to claim 24, wherein a tangential component of a magnetic field of the radiation reflected by the VMW is out of phase with the tangential component of the magnetic field of the radiation incident on the VMW by approximately 180°.

28. A shield according to claim 24, wherein the VMW comprises a front surface and a back surface, which define at least one cavity therebetween, having a resonance in a vicinity of the given frequency.

29. An assembly according to claim 28, wherein at least one slot is formed in the front surface of the VMW, opening into the cavity.

30. An assembly according to claim 29, wherein the at least one slot comprises a plurality of slots.

31. An assembly according to claim 29, wherein the at least one slot is oriented responsive to the polarization of the emitted radiation.

32. A shield according to claim 29, wherein the VMW further comprises one or more lumped circuit elements coupled across the at least one slot.

33. An assembly according to claim 28, wherein the at least one cavity comprises a plurality of cavities.

34. An assembly according to claim 28, wherein the VMW comprises one or more fins, positioned in the at least one cavity so as to enhance a capacitance of the cavity.

35. An assembly according to claim 34, wherein at least one of the one or more fins is oriented in a direction generally perpendicular to the surfaces of the VMW.

36. An assembly according to claim 34, wherein at least one of the one or more fins is oriented in a direction generally parallel to the surfaces of the VMW.

37. An assembly according to claim 28, wherein the VMW comprises a dielectric or magnetic material, which is contained in the at least one cavity.

38. A shield according to claim 24, wherein the VMW comprises an array of inductors and capacitors, arranged to form one or more circuits having a resonance in a vicinity of the given frequency.

39. An assembly according to claim 38, wherein the array comprises one or more inductive coils, having gaps therein that define the capacitors.

40. A shield according to claim 24, wherein the VMW comprises a surface having periodic corrugations therein, which are configured to block electric currents from flowing over the surface.

41. A shield according to claim 24, wherein the VMW comprises a surface and one or more shorted transmission lines having input terminals at the surface and configured to exhibit an open circuit at the input terminals.

42. An assembly according to claim 41, wherein the transmission lines comprise folded transmission lines.

43. An assembly according to claim 41, wherein the transmission lines comprise meandered transmission lines.

44. An assembly according to claim 41, wherein the transmission lines are approximately one quarter wave in length in the given frequency band.

45. A shield according to claim 24, wherein the VMW comprises a structure having a resonance in the given frequency band, which is configured to respond to the incident radiation as an open-circuited resonant circuit.

46. A shield according to claim 24, wherein the antenna comprises a monopole antenna.

47. A shield according to claim 24, wherein the antenna comprises an array of antennas.

48. A shield according to claim 24, wherein the given frequency band is between approximately 800 and 900 MHz.

49. A shield according to claim 24, wherein the given frequency band is between approximately 1800 and 1900 MHz.

50. A method for shielding an object from radiation emitted by an antenna in a given frequency band and having a given polarization, the method comprising positioning a virtual magnetic wall (VMW) between the antenna and the object so as to reflect the radiation emitted by the antenna away from the object, such that an electric field of the radiation reflected by the VMW is substantially in phase with the electric field of the emitted radiation incident on the VMW.

51. A method according to claim 50, wherein positioning the VMW comprises placing the VMW at a distance from the antenna that is substantially less than one quarter of a wavelength of the radiation.

52. A method according to claim 50, wherein positioning the VMW comprises positioning a device that emulates a perfect magnetic conductive surface between the antenna and the object.

53. A method according to claim 50, wherein positioning the VMW comprises arranging the VMW between the antenna and the object so that a tangential component of a magnetic field of the radiation reflected by the VMW is out of phase with the tangential component of the magnetic field of the radiation incident on the VMW by approximately 180°.

54. A shield according to claim 50, wherein positioning the VMW comprises providing a cavity between the antenna and the object having a resonance in a vicinity of the given frequency.

55. A method according to claim 54, wherein providing the cavity comprises creating at least one slot in a front surface of the VMW, opening into the cavity.

56. A method according to claim 55, wherein creating the at least one slot comprises orienting the slot responsive to the polarization of the emitted radiation.

57. A method according to claim 55, wherein providing the cavity further comprises coupling one or more lumped circuit elements across the at least one slot.

58. A method according to claim 54, wherein providing the cavity comprises providing a plurality of cavities.

59. A method according to claim 54, wherein providing the cavity comprises positioning one or more fins in the cavity so as to enhance a capacitance of the cavity.

60. A method according to claim 54, wherein providing the cavity comprises filling the cavity with a dielectric or magnetic material.

61. A shield according to claim 50, wherein positioning the VMW comprises placing an array of inductors and capacitors between the antenna and the object, wherein the inductors and capacitors are arranged to form one or more circuits having a resonance in a vicinity of the given frequency.

62. A shield according to claim 50, wherein positioning the VMW comprises providing a surface between the antenna and the object, the surface having periodic corrugations therein, which are configured to block electric currents from flowing over the surface.

63. A shield according to claim 50, wherein positioning the VMW comprises providing a surface between the antenna and the object and providing one or more shorted transmission lines with input terminals at the surface, wherein the transmission lines are configured to exhibit an open circuit at the input terminals.

64. A shield according to claim 50, wherein positioning the VMW comprises placing a resonant structure between the antenna and the object, wherein the structure has a resonance in the given frequency band and is configured to respond to the incident radiation as an open-circuited resonant circuit.

65. A shield according to claim 50, wherein the given frequency band is between approximately 800 and 900 MHz.

66. A shield according to claim 50, wherein the given frequency band is between approximately 1800 and 1900 MHz.
